(19) United States
(12) Patent Application Publication
(10) Pub. No.: US 2021/0075948 A1
(43) Pub. Date: Mar. 11, 2021

(54) EXPOSURE CONTROL APPARATUS

(71) Applicant: TOYOTA JIDOSHA KABUSHIKI KAISHA, Toyota-shi (JP)

(72) Inventor: Masakazu NISHIJIMA, Ebina-shi (JP)

(73) Assignee: TOYOTA JIDOSHA KABUSHIKI KAISHA, Toyota-shi (JP)

(21) Appl. No.: 16/923,368

(22) Filed: Jul. 8, 2020

(30) Foreign Application Priority Data
Sep. 10, 2019 (JP) 2019-164566

(51) Int. Cl. H04N 5/235

(52) U.S. Cl. CPC H04N 5/2353; H04N 5/2351

(57) ABSTRACT

An exposure control apparatus is for a camera mounted in a vehicle including a lamp. The exposure control apparatus includes: an exposure setter setting an exposure time of the camera in each frame period and cyclically changing the exposure times of the camera in each predetermined period with a length equal to, or an integral multiple of, a length of a change cycle of the quantity of light of the lamp and including a plurality of frame periods; and an adjuster setting a calibration period for setting the exposure times. The exposure setter sets the exposure times in the plurality of frame periods to be constant in the calibration period, and sets the exposure time in each of the plurality of frame periods, based on a degree of brightness of each of a plurality of images picked up by the camera during the calibration period.

### INCORPORATION BY REFERENCE

The disclosure of Japanese Patent Application No. 2019-164566 filed on Sep. 10, 2019 including the specification, drawings and abstract is incorporated herein by reference in its entirety.

### BACKGROUND

### 1. Technical Field

The disclosure relates to a technical field of an exposure control apparatus for an in-vehicle camera.

### 2. Description of Related Art

In some of vehicles in which apparatuses for exposure control are mounted, for example, the quantity of light of head lamps changes at a relatively short cycle (for example, from tens of milliseconds to hundreds of milliseconds). An in-vehicle camera picks up images in succession at a predetermined frame rate. In a case of a frame rate of, for example, 30 fps (frames per second), since one frame period is approximately 33.3 milliseconds, the quantity of light in each frame period changes when the quantity of light of head lamps changes at a relatively short cycle. It has been known that due to changes in the quantity of light of head lamps on an every frame period basis, different detection-target objects in different scenes, such as with presence or absence of light emission and difference between day and night, can be detected from images picked up by an in-vehicle camera, and thus target recognition accuracy of the in-vehicle camera can be enhanced.

For example, Japanese Patent Application Publication No. 2017-193239 proposes a technique in which when an in-vehicle camera with a fixed ratio between an exposure time and a non-exposure time in one frame period picks up images of an ambient space around a vehicle, a lit-up state of head lamps is controlled such that average intensity of pulse light during the exposure time is greater than average intensity of pulse light during the non-exposure time (see JP 2017-193239 A).

### SUMMARY

The technique described in JP 2017-193239 A has a technical problem that changes in the cyclically changing quantity of light of the head lamps need to be controlled to coincide with the exposure time in each frame period of the camera; more specifically, in order to set an exposure time corresponding to a period in which the quantity of light of the head lamps is larger and an exposure time corresponding to a period in which the quantity of light of the head lamps is smaller, synchronization processing needs to be performed for establishing synchronization between the head lamps and the in-vehicle camera that are different parts.

The disclosure is made in light of the above problem, and an object of the embodiment is to provide an exposure control apparatus that enables images to be picked up with an appropriate exposure time without performing synchronization processing even if the quantity of light of a lamp such as head lamps cyclically changes.

An exposure control apparatus according to an aspect of the disclosure is an exposure control apparatus for a camera that picks up images of surroundings of a vehicle in the vehicle including a lamp of which a quantity of light cyclically changes when the lamp is lit, including: an exposure setter that sets an exposure time of the camera in each frame period and cyclically changes the exposure times of the camera in each predetermined period that is a period with a length equal to, or an integral multiple of, a length of a change cycle of the quantity of light of the lamp and is a period including a plurality of frame periods; and an adjuster that sets a calibration period that is a period for setting the exposure times, wherein the exposure setter sets the exposure times in the plurality of frame periods to be constant in the calibration period, and sets the exposure time in each of the plurality of frame periods, based on a degree of brightness of each of a plurality of images picked up by the camera during the calibration period.

The degree of brightness of each of the plurality of images picked up during the calibration period reflects a change in the quantity of light of the lamp because the exposure times are constant. Accordingly, by referring to the degree of brightness of each of the plurality of images, a change pattern of the quantity of light of the lamp can be estimated without acquiring, for example, control information related to the lamp (the change pattern of the quantity of light, or the like), that is, without performing synchronization processing for the lamp and the camera. Accordingly, the exposure control apparatus can set the exposure time in each of the plurality of frame periods, based on the degree of brightness of each of the plurality of images picked up during the calibration period. Hence, according to the exposure control apparatus, even if the quantity of light of the lamp cyclically changes, an image can be picked up with an appropriate exposure time, without performing synchronization processing.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a block diagram showing a configuration of an exposure control apparatus according to a first embodiment;

FIG. 2 shows an example of a relationship between an image pick-up cycle and a change cycle of a quantity of light;

FIG. 3A shows an example of exposure times in a calibration period;

FIG. 3B shows an example of images picked up during the calibration period;

FIG. 4 shows examples of exposure times set by the exposure control apparatus according to the first embodiment; and

FIG. 5 is a flowchart showing operation of the exposure control apparatus according to the first embodiment.

### DETAILED DESCRIPTION OF EMBODIMENTS

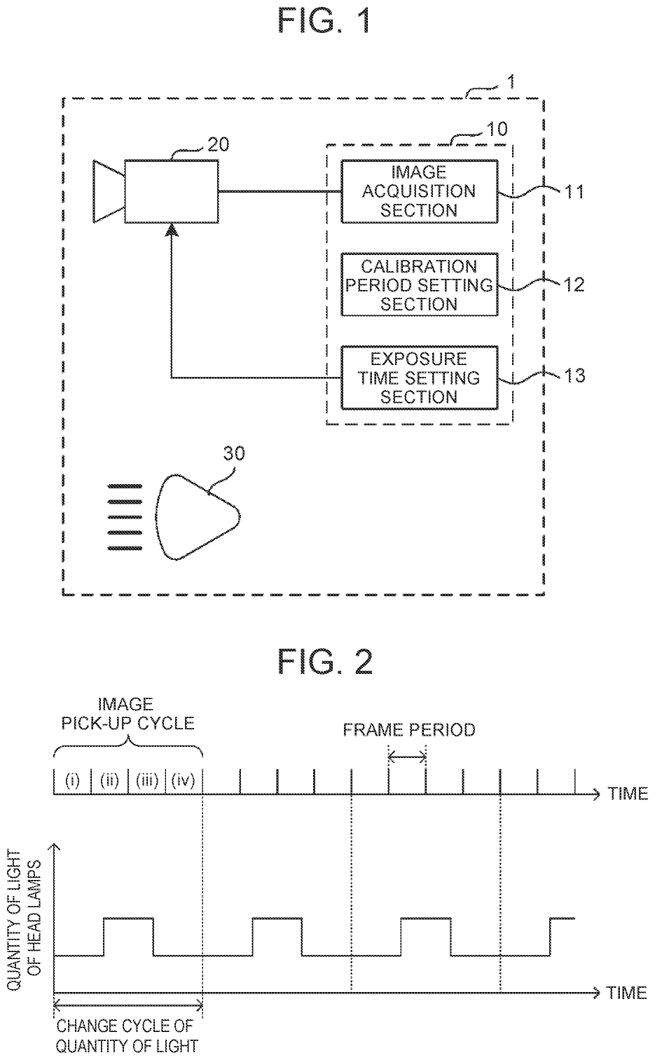

An embodiment related to an exposure control apparatus will be described with reference to FIGS. 1 to 5.

The exposure control apparatus according to the embodiment is an exposure control apparatus for a camera that picks up images of surroundings of a vehicle in the vehicle including a lamp of which the quantity of light cyclically changes when the lamp is lit. The exposure control apparatus includes: an exposure setter that sets an exposure time of the camera in each frame period and cyclically changes the exposure times of the camera in each predetermined period that is a period with a length equal to, or an integral multiple of, a length of a change cycle of the quantity of light of the lamp and is a period including a plurality of frame periods; and an adjuster that sets a calibration period that is a period for setting the exposure times.

The exposure setter sets an exposure time in each frame period. A reason for such setting is as follows, for example. Specifically, image pick-up targets of the camera include objects that emit light, such as traffic lights and head lamps of oncoming vehicles on one hand, and also include objects that exist in relatively dark places, such as portions shadowed by vehicles and structures on the other hand. At the time, if the exposure times in all frame periods are set relatively short such that, for example, an image of a traffic light can be appropriately picked up, relatively dark areas in the image may become blocked-up shadows. On the other hand, if the exposure times in all frame periods are set relatively long such that, for example, an image of a relatively dark place can be appropriately picked up, relatively bright areas in the image may become blown-out highlights. Accordingly, an attempt is made to acquire an image in which relatively bright areas are appropriately imaged and an image in which relatively dark areas are appropriately imaged, by setting the exposure time in one frame period relatively short, and setting the exposure time in another frame period following the one frame period relatively long.

The “lamp” typically refers to head lamps, but may be, for example, tail lamps or the like as long as the quantity of light cyclically changes when the lamp is lit. Here, a reason why the quantity of light of the lamp cyclically changes is as follows, for example. Specifically, an upper limit is defined to quantities of light that are applicable on roads. Accordingly, when the quantity of light of a lamp is constant regardless of time, a maximum value of the quantity of light of the lamp is constrained to some degree, and consequently images picked up by an in-vehicle camera at night are relatively dark in many cases. Accordingly, an attempt is made to make it possible to pick up relatively bright images even at night, by making the quantity of light of the lamp relatively large in one relatively short period (for example, such that the quantity of light exceeds the maximum value of the quantity of light in the case where the quantity of light is constant regardless of time), and also making the quantity of light of the lamp relatively small in another period following the one period.

However, since the lamp and the camera are different parts, images as expected cannot be picked up unless any measure is devised. Accordingly, according to the exposure control apparatus, the calibration period that is a period for setting the exposure times is set by the adjuster. The calibration period may be set, for example, immediately after the vehicle is started (that is, immediately after the vehicle falls in Ready ON state), immediately after the lamp is lit, or the like.

The exposure setter first sets the exposure times in all frame periods to be constant in the calibration period. Thereafter, the exposure setter sets the exposure time in each of a plurality of frame periods included in the predetermined period, based on a degree of brightness (for example, a luminance value) of each of a plurality of images picked up by the camera during the calibration period.

Since the exposure times in all frame periods are constant in the calibration period, it can be regarded that a difference in the degree of brightness of each of the plurality of images corresponds to a change in the quantity of light of the lamp. Accordingly, the exposure setter can estimate a change pattern of the quantity of light of the lamp, based on the degree of brightness of each of the plurality of images. As a result, the exposure setter can set the exposure time in each of the plurality of frame periods, with consideration for changes in the quantity of light of the lamp.

The exposure control apparatus can set the exposure time in each of the plurality of frame periods, in particular, without acquiring control information related to the lamp (in other words, without performing synchronization processing for the lamp and the camera).

### First Embodiment

In FIG. 1, an exposure control apparatus 10 as a specific example of the exposure control apparatus controls exposure of a camera 20 mounted in a vehicle 1. The vehicle 1 includes a head lamp unit 30 (hereinafter, referred to as “head lamps 30” as appropriate) corresponding to an example of the “lamp”. The camera 20 is attached to the vehicle 1, for example, such as to be able to pick up images of scenes ahead of the vehicle 1.

The exposure control apparatus 10 includes an image acquisition section 11, a calibration period setting section 12, and an exposure time setting section 13. The “calibration period setting section 12” and the “exposure time setting section 13” correspond to examples of the “adjuster” and the “exposure setter”, respectively. Note that the exposure control apparatus 10 and the camera 20 may be configured as a single unit.

Here, it is assumed that the exposure control apparatus 10 sets exposure times of the camera 20 to, for example, any of a relatively long exposure time, a relatively short exposure time, and an intermediate exposure time between the relatively long exposure time and the relatively short exposure time. Hereinafter, a case in which an exposure time is set to the relatively long exposure time will be referred to as “night-time high-luminance mode” as appropriate. Hereinafter, a case in which an exposure time is set to the relatively short exposure time will be referred to as “light-emitting object mode” as appropriate. Hereinafter, a case in which an exposure time is set to the intermediate exposure time will be referred to as “night-time normal mode” as appropriate.

The “night-time high-luminance mode” is an exposure mode designed to appropriately pick up an image of an object existing in a relatively dark place. An image picked up in the night-time high-luminance mode has a relatively high mean luminance value. The “light-emitting object mode” is an exposure mode designed to appropriately pick up an image of an object emitting light or an object easily reflecting light such as a traffic light, head lamps of an oncoming vehicle, or a reflector. The “night-time normal mode” may be an exposure mode designed to appropriately pick up images of a moving obstacle such as another vehicle, a bicycle, or a pedestrian, and a lane. In such a case, the intermediate exposure time may be set as a time period in which occurrence of image misalignment in an image is restrained.

The exposure control apparatus 10 may control the exposure times of the camera 20 by changing the exposure modes in the order of, for example, the night-time high-luminance mode, the night-time normal mode, the light-emitting object mode, the night-time normal mode, and the night-time high-luminance mode such that one cycle of exposure modes is made in four frame periods. Hereinafter, a period in which one cycle of exposure modes is made will be referred to as “image pick-up cycle” as appropriate. Note that the “image pick-up cycle” corresponds to an example of the “predetermined period”.

In the embodiment, it is assumed that one cycle of the image pick-up cycles corresponds to one change cycle of the quantity of light of the head lamps 30, for example, as shown FIG. 2. Based on the premise, a method in which the exposure control apparatus 10 determines an exposure mode in each of the four frame periods (i) to (iv) included in each image pick-up cycle (that is, an exposure time setting method) will be described.

The calibration period setting section 12 of the exposure control apparatus 10 sets the calibration period on the condition that, for example, the vehicle 1 is started or the head lamps 30 are lit. The calibration period is a period equal to or longer than one cycle of the image pick-up cycles. An upper limit on the calibration period may be set as a value that prevents functions using an image picked up by the camera 20, such as an obstacle recognition function and a white line recognition function, from being affected.

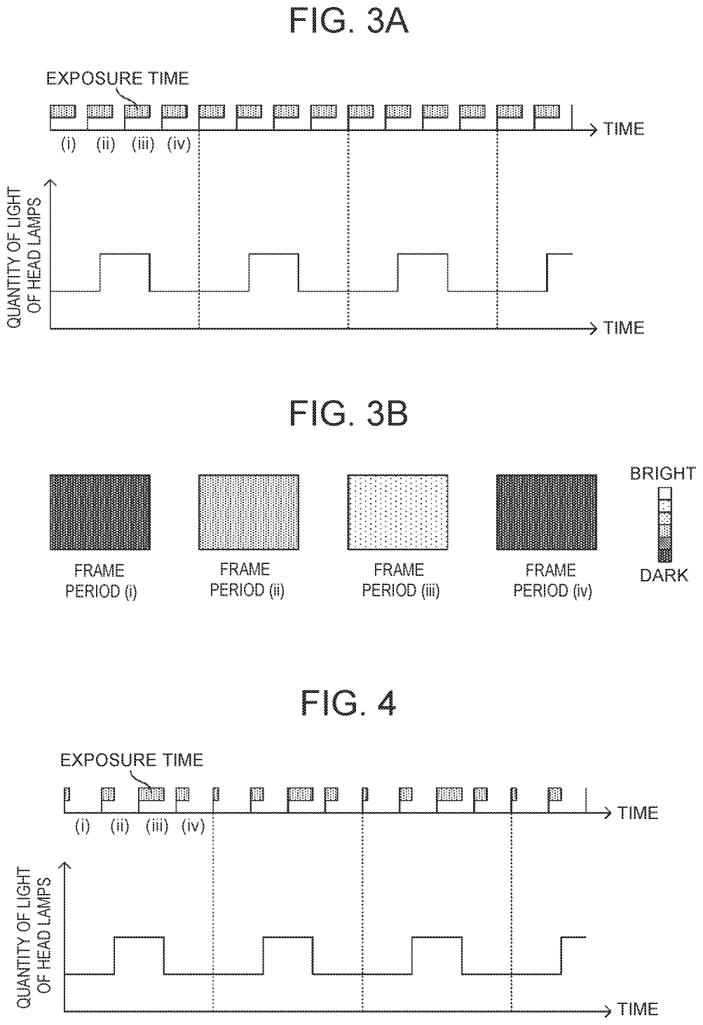

In the calibration period, the exposure time setting section 13 of the exposure control apparatus 10 first sets the exposure times in all frame periods to be constant, for example, as shown in FIG. 3A. The then exposure times may have an arbitrary length. However, it is preferable that the exposure times be set relatively long such that clear differences in degree of brightness can be seen among a plurality of images picked up in the individual frame periods.

After the exposure times are set constant, the exposure time setting section 13 acquires a plurality of temporally consecutive images picked up by the camera 20 via the image acquisition section 11. At the time, for example, images as shown in FIG. 3B are picked up in the frame periods (i) to (iv), respectively. Subsequently, the exposure time setting section 13 calculates a mean luminance value of each of the plurality of images. In the example shown in FIG. 3B, the image picked up in the frame period (iii) has the highest mean luminance value, and the images picked up in the frame periods (i) and (iv) have the lowest mean luminance values, due to a relationship between a change in the quantity of light of the head lamps 30 and each exposure time.

Based on the mean luminance value of each image, the exposure time setting section 13 sets an exposure mode for the frame period in which the image with the highest mean luminance value is picked up, to the night-time high-luminance mode. In the example shown in FIGS. 3A and 3B, the exposure time setting section 13 sets an exposure mode for the frame period (iii) to the night-time high-luminance mode.

Subsequently, the exposure time setting section 13 sets an exposure mode for each frame period other than the frame period set in the night-time high-luminance mode such that the exposure modes change in the order of, for example, the night-time high-luminance mode, the night-time normal mode, the light-emitting object mode, and the night-time normal mode. In the example shown in FIGS. 3A and 3B, the exposure time setting section 13 sets exposure modes for the frame periods (ii) and (iv) to the night-time normal mode, and sets an exposure mode for the frame period (i) to the light-emitting object mode. As a result, the exposure time in each frame period is set, for example, as shown in an upper side of FIG. 4. As described above, the exposure time setting section 13 may set the exposure time in the frame period in which the image with the higher mean luminance value is picked up, to be longer than the exposure times in the frame periods in which the images with the lower mean luminance values are picked up.

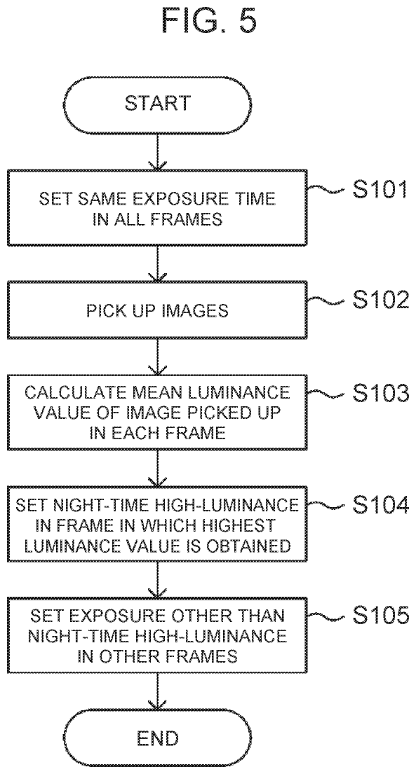

An additional description will be given of operation of the exposure control apparatus 10 during the calibration period, with reference to a flowchart of FIG. 5.

In the calibration period set by the calibration period setting section 12, the exposure time setting section 13 first sets the exposure times in all frame periods to be constant (step S101). Thereafter, images of scenes ahead of the vehicle 1 are picked up by the camera 20 (step S102). At the time, the image acquisition section 11 acquires a plurality of temporally consecutive images picked up by the camera 20.

Subsequently, the exposure time setting section 13 calculates a mean luminance value of each of the plurality of images (step S103). Subsequently, the exposure time setting section 13 sets an exposure mode for the frame period in which an image with the highest mean luminance value is picked up to the night-time high-luminance mode (step S104). Thereafter, the exposure time setting section 13 sets an exposure mode for each frame period other than the frame period set in the night-time high-luminance mode (step S105).

### Technical Advantageous Effects

According to the exposure control apparatus 10, since the exposure time in every frame period is set constant in the calibration period, a change pattern of the quantity of light of the head lamps 30 can be estimated from a plurality of temporally consecutive images picked up during the calibration period. In other words, the exposure control apparatus 10 can estimate a change pattern of the quantity of light of the head lamps 30, without acquiring control information related to the head lamps 30 (for example, the change pattern of the quantity of light) from the head lamps 30, that is, without performing synchronization processing for the camera 20 and the head lamps 30.

According to the exposure control apparatus 10, since an exposure mode (that is, an exposure time) for each frame period is set with consideration for the change pattern of the quantity of light estimated as described above, synchronization can be established between the camera 20 and the head lamps 30, despite not performing the synchronization processing. Accordingly, an image of an object existing in a relatively dark place can be appropriately picked up in a frame period in which the quantity of light of the head lamps 30 is relatively large, and an image of an object emitting light or an object easily reflecting light can be appropriately picked up in a frame period in which the quantity of light of the head lamps 30 is relatively small.

Note that an image picked up in the frame period set in the night-time high-luminance mode may be used, for example, by the obstacle recognition function to detect a distant fallen object or the like at a place relatively far away from the vehicle 1. An image picked up in the frame period set in the night-time normal mode may be used, for example, by the obstacle recognition function to detect, for example, a moving obstacle such as another vehicle, or, for example, by the white line (lane) recognition function to detect a white line. Frequency of detecting a moving obstacle, a white line (lane), and the like can be enhanced by configuring one cycle of the image pick-up cycles to include relatively many frame periods set in the night-time normal mode. An image picked up in the frame period set in the night-time high-luminance mode may also be used to detect a moving obstacle, a white line (lane), and the like. With such a configuration, frequency of detecting a moving obstacle, a white line (lane), and the like can be further enhanced.

### Second Embodiment

In the first embodiment described above, an exposure time in each frame period included in one cycle of the image pick-up cycles is set such that the exposure modes change in the order of the night-time high-luminance mode, the night-time normal mode, the light-emitting object mode, and the night-time normal mode.

In a second embodiment, the exposure control apparatus 10 does not need to determine beforehand the order in which the exposure modes change. In such a case, the exposure time setting section 13 may set an exposure time (or an exposure mode) in each frame period included in one cycle of the image pick-up cycles, based on the mean luminance value of each of a plurality of images picked up during the calibration period, such that, within the one cycle of the image pick-up cycles, a shorter exposure time is set in a frame period that is temporally farther from a frame period in which an image with the highest mean luminance value is picked up.

Specifically, in the calibration period, the exposure time setting section 13 first sets the exposure times in all frame periods to be constant, for example, as shown in FIG. 3A. At the time, it is assumed that, for example, images as shown in FIG. 3B are picked up in the frame periods (i) to (iv) of FIG. 3A, respectively.

Subsequently, the exposure time setting section 13 calculates a mean luminance value of each of the plurality of images. In the example shown in FIG. 3B, the image picked up in the frame period (iii) of FIG. 3A has the highest mean luminance value, and the images picked up in the frame periods (i) and (iv) have the lowest mean luminance values, due to a relationship between a change in the quantity of light of the head lamps 30 and each exposure time.

Based on the mean luminance value of each image, the exposure time setting section 13 sets the exposure time in the frame period in which the image with the highest mean luminance value is picked up to be longest. In the example shown in FIGS. 3A and 3B, the exposure time setting section 13 sets the exposure time in the frame period (iii) to be longest.

Thereafter, in one cycle of the image pick-up cycles, the exposure time setting section 13 sets a shorter exposure time in a frame period that is temporally farther from the frame period (iii). As a result, the exposure time in the frame period (i) is set shortest. The exposure times in the frame periods (ii) and (iv) are set to be exposure times that are shorter than the exposure time in the frame period (iii) and longer than the exposure time in the frame period (i). In other words, the exposure time in each frame period is set, for example, as shown in the upper side of FIG. 4.

### Third Embodiment

In a third embodiment, the order in which the exposure modes change does not need to be determined beforehand, as in the second embodiment described above. In such a case, the exposure time setting section 13 may set an exposure time (or an exposure mode) in each frame period included in one cycle of the image pick-up cycles, based on the mean luminance value of each of a plurality of images picked up during the calibration period, such that a longer exposure time is set in a frame period in which a higher mean luminance value is obtained.

It is assumed that, for example, images as shown in FIG. 3B are picked up during the calibration period. In the example shown in FIG. 3B, the image picked up in the frame period (iii) has the highest mean luminance value, and the images picked up in the frame periods (i) and (iv) have the lowest mean luminance values, due to a relationship between a change in the quantity of light of the head lamps 30 and each exposure time.

At the time, the exposure time setting section 13 sets the exposure time in the frame period (iii) in which the highest mean luminance value is obtained to be longest. The exposure time setting section 13 sets the exposure times in the frame periods (i) and (iv) in which the lowest mean luminance value is obtained to be shortest. The exposure time setting section 13 sets the exposure time in the frame period (ii) in which a middle-level mean luminance value is obtained to be an exposure time that is shorter than the exposure time in the frame period (iii) and longer than the exposure time in the frame period (i).

### Modification Examples

(1) The exposure modes are not limited to the above-described “night-time high-luminance mode”, “night-time normal mode”, and “light-emitting object mode”. Specifically, for example, the “light-emitting object mode” may be subdivided into a “light source mode” in which an image of a light source such as a traffic light can be appropriately picked up, and a “high-reflection mode” in which an image of an object easily reflecting light such as a reflector can be appropriately picked up. Note that an exposure time for the light source mode is set short compared to an exposure time for the high-reflection mode.

(2) For example, in order to handle a flicker phenomenon due to artificial light such as an LED (Light Emitting Diode) traffic light, a plurality of frame periods set in the light-emitting object mode may be consecutively arranged in one cycle of the image pick-up cycles.

(3) One cycle of the image pick-up cycles may correspond to an integral multiple of (that is, twice, three times, four times, . . . ) one change cycle of the quantity of light of the head lamps 30. With such a configuration, for example, the configurations of (1) and (2) above can be relatively easily implemented.

(4) Even if the quantity of light of the head lamps 30 changes, no significant difference in mean luminance value (in other words, degree of brightness) may occur among a plurality of images picked up during the calibration period, depending on a quantity of light around the vehicle 1 (that is, a quantity of environmental light). Accordingly, when a difference in mean luminance value between an image with a highest mean luminance value and an image with a lowest mean luminance value among the plurality of images picked up during the calibration period is smaller than a predetermined value, the exposure time setting section 13 may discontinue setting exposure times (for example, the processing shown in the flowchart of FIG. 5).

Various aspects of the disclosure derived from the above-described embodiments and modification examples will be described below.

An exposure control apparatus according to an aspect of the disclosure is an exposure control apparatus for a camera that picks up images of surroundings of a vehicle in the vehicle including a lamp of which a quantity of light cyclically changes when the lamp is lit, including: an exposure setter that sets an exposure time of the camera in each frame period and cyclically changes the exposure times of the camera in each predetermined period that is a period with a length equal to, or an integral multiple of, a length of a change cycle of the quantity of light of the lamp and is a period including a plurality of frame periods; and an adjuster that sets a calibration period that is a period for setting the exposure times, wherein the exposure setter sets the exposure times in the plurality of frame periods to be constant in the calibration period, and sets the exposure time in each of the plurality of frame periods, based on a degree of brightness of each of a plurality of images picked up by the camera during the calibration period.

In an aspect of the exposure control apparatus, the exposure setter sets the exposure time in the frame period in which an image with a larger degree of brightness is picked up to be longer than the exposure time in the frame period in which an image with a smaller degree of brightness is picked up.

In another aspect of the exposure control apparatus, the exposure setter sets the exposure times such that a longer exposure time is set in a frame period as an image picked up in the frame period has a larger degree of brightness.

In another aspect of the exposure control apparatus, the exposure setter sets the exposure times such that a shorter exposure time is set in a frame period as the frame period is temporally farther from a frame period in which an image with the largest degree of brightness is picked up among the plurality of frame periods.

The disclosure is not limited to the embodiments described above, and various modifications can be made as appropriate without departing from the gist or the idea of the disclosure which can be understood from the claims and the description in its entirety, and the exposure control apparatus with such modifications are also incorporated in the technical scope of the disclosure.

What is claimed is:

1. An exposure control apparatus for a camera that picks up images of surroundings of a vehicle in the vehicle including a lamp of which a quantity of light cyclically changes when the lamp is lit, comprising:
an exposure setter that sets an exposure time of the camera in each frame period and cyclically changes the exposure times of the camera in each predetermined period that is a period with a length equal to, or an integral multiple of, a length of a change cycle of the quantity of light of the lamp and is a period including a plurality of frame periods; and
an adjuster that sets a calibration period that is a period for setting the exposure times,
wherein the exposure setter sets the exposure times in the plurality of frame periods to be constant in the calibration period, and
sets the exposure time in each of the plurality of frame periods, based on a degree of brightness of each of a plurality of images picked up by the camera during the calibration period.

2. The exposure control apparatus according to claim 1, wherein the exposure setter sets an exposure time in a frame period in which an image with a larger degree of the brightness is picked up to be longer than an exposure time in a frame period in which an image with a smaller degree of the brightness is picked up.

3. The exposure control apparatus according to claim 1, wherein the exposure setter sets exposure times such that a longer exposure time is set in a frame period as an image picked up in the frame period has a larger degree of the brightness.

4. The exposure control apparatus according to claim 1, wherein the exposure setter sets exposure times such that a shorter exposure time is set in a frame period as the frame period is temporally farther from a frame period in which an image with a largest degree of the brightness is picked up among the plurality of frame periods.
